(19) United States
(12) Patent Application Publication
(10) Pub. No.: US 2019/0303413 A1
(43) Pub. Date: Oct. 3, 2019

(54) EMBEDDING MEDIA CONTENT ITEMS IN TEXT OF ELECTRONIC DOCUMENTS

(71) Applicant: Vidy, Inc., San Francisco, CA (US)

(72) Inventor: Patrick M. Colangelo, San Francisco, CA (US)

(21) Appl. No.: 16/178,511

(22) Filed: Nov. 1, 2018

Related U.S. Application Data
(62) Division of application No. 15/942,247, filed on Mar. 30, 2018.

(51) Int. Cl. G06F 16/93; G06F 16/31; G06F 16/48

(52) U.S. Cl. CPC G06F 16/94; G06F 16/48; G06F 16/313

(57) ABSTRACT

A playable media content item is received. An electronic document that includes text is accessed, and a portion of text of the electronic document is analyzed by natural language processing to extract a keyword associated with the portion of text. The media content item is associated with the portion of text based on a determined match the media content item and the keyword associated with the portion of text. The association is sent over a computer network to a publisher of the electronic document for linking the media content item to the portion of text.

### CROSS-REFERENCE TO RELATED APPLICATIONS

This application is a divisional of U.S. patent application Ser. No. 15/942,247, filed Mar. 30, 2018, which is incorporated herein by reference in its entirety.

### TECHNICAL FIELD

This application relates generally to embedding media content in electronic documents, and in particular to embedding media content in text of electronic documents.

### BACKGROUND

Electronic documents are commonly supplemented by media content items, such as pictures, audio recordings, or video recordings. If a reader of an electronic document desires to view media content items pertaining to the document, the reader often must leave the context of the document to open and view the media content item in a new web page or new application. To avoid this inconvenience, many publishers of electronic documents embed supplemental media content items into the electronic documents.

One common type of media content provided with electronic documents is video or graphical advertisements. When a web page, for example, is requested by a user device, advertisements are provided to the user device and displayed within or over the web page. Publishers earn revenue from advertisers by providing these advertisements, typically by either a cost-per-impression model or a cost-per-click model. Revenue calculated using these models is typically correlated to a number of advertisements that are shown to users, and publishers are therefore incentivized to allocate significant space (often called “real estate”) to advertisements on web pages.

However, end users typically dislike advertisements in electronic documents. Taking space and attention away from the substantive content of the page, these advertisements offer users little more than frustration. Furthermore, advertisements in an electronic document increase the amount of bandwidth consumed and power used by user devices when retrieving the document over a network. For mobile devices in particular, which typically have smaller capacity batteries than larger devices and may receive data by a monthly or prepaid subscription that caps the amount of data that may be downloaded by the device, the power and data used by unwanted advertisements can be a significant burden. To avoid these problems, users may install ad blockers on their devices and opt out of the advertising ecosystem altogether, resulting in lost revenue for publishers and decreased reach for advertisers.

### BRIEF DESCRIPTION OF THE DRAWINGS

FIG. 1A illustrates an environment for embedding media content items in electronic documents.

FIG. 1B is a schematic illustrating an example implementation of the environment for embedding media content items in electronic documents.

FIG. 2A is a block diagram illustrating functional modules executable by a media embedding system.

FIG. 2B is a block diagram illustrating a user device.

FIG. 3 is an interaction diagram illustrating a process for associating media content items with portions of text in an electronic document.

FIG. 4 is an interaction diagram illustrating a process for embedding media content items into portions of text in an electronic document.

FIGS. 5A-5E illustrate an example electronic document including an associated media content item and displayed by a user device.

FIG. 6 is a block diagram illustrating a processing system.

### DETAILED DESCRIPTION

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

### System Overview

A media embedding system associates playable media content items, such as video or audio recordings, with portions of text in an electronic document, such as a web page. Based on the association, a selectable link to the media content is generated in the electronic document at the portion of text prior to when the document is viewed by a user. When the document is viewed by the user on a user device, selection of the link by the user will cause the user device to display the media content item on the electronic document. When compared to embedded media content that is loaded and displayed when an electronic document is requested by a user device, as done by conventional techniques, the embedded selectable link reduces the power and data usage of the user device. For example, a media content item that is matched to a document is not requested and displayed until a user selects the selectable link associated with the item. The user therefore has the choice to view the media content item, or continue reading the document without viewing the item. By not distracting the user with external media content items, the amount of time the user spends on the electronic document may increase. Furthermore, when the media content items are advertisements, the publisher and advertiser can accurately determine when an ad impression has occurred and thereby more easily calculate advertisement budgets.

The selectable links may be generated within an embedding layer that operates in parallel with and transparently to an application displaying the electronic document. In addition to providing the selectable links, the embedding layer may track and report event data resulting from user interactions with an entire document, including both portions of text associated with media content items and portions of text not associated with media content items.

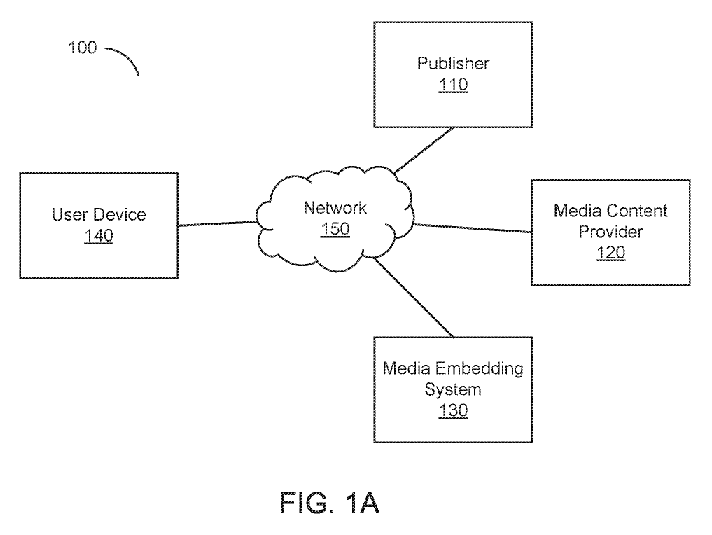

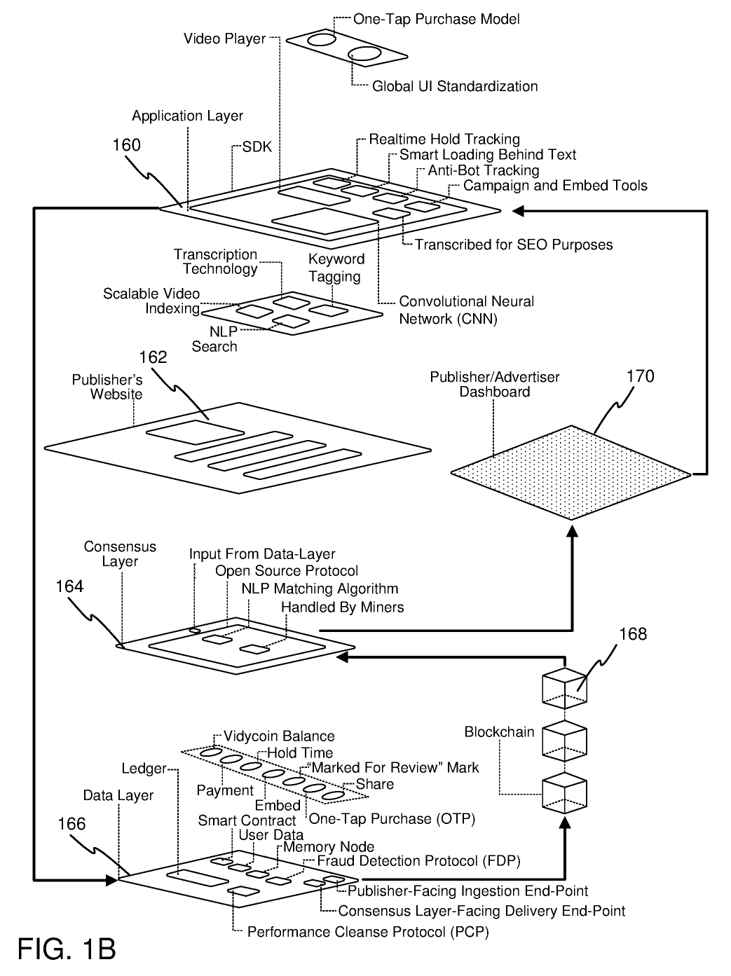

FIG. 1A illustrates an environment 100 for embedding media content items in electronic documents, according to one embodiment. As shown in FIG. 1A, the environment 100 may include a publisher 110, a media content provider 120, a media embedding system 130, and a user device 140 communicatively coupled over a network 150. The environment 100 may include additional or fewer components than are shown. For example, the environment 100 may include a plurality of publishers 110, media content providers 120, or user devices 140.

The publisher 110 provides electronic documents for display by the user device 140. The electronic documents provided by the publisher 110 include text, and may be any of a variety of content communicable over the network 150, such as web pages, electronic books or magazines, or applications. In addition to textual content, each electronic document can include computer-readable code that defines a structure of the document and/or actions performable within the document. Media content items are embedded into one or more portions of the text in an electronic document. When displayed on a user device 140, the portion of text associated with embedded content is selectable to display the embedded content. The publisher 110 may generate links to media content items in their electronic documents by using a software development kit (SDK) distributed by the media embedding system 130, which incorporates additional computer program code into the computer program code for the document provided by the publisher 110. When executed on a user device (e.g., by a browser application), the additional incorporated code causes the user device to display one or more actionable user interface elements related to the embedded content and enable users to interact with the media content items. The incorporated code may also cause the user device to report event data associated with a document or media content items to the media embedding system 130 for analysis.

The media content provider 120 provides media content items that are to be embedded into the electronic documents. Media content items may be playable content items, such as digital video or audio recordings. The media content provider 120 may comprise a content hosting platform storing media content and distributing content items for display to users, or the media content provider 120 may send content items to the media embedding system 130 for hosting.

The media embedding system 130 generates associations between media content items and electronic documents based on determined matches between keywords of the media content items and the electronic documents. The media embedding system 130 can include a centralized entity, such as one or more servers configured to perform various operations described herein. Additionally or alternatively, the media embedding system 130 may include a plurality of devices performing decentralized operations. For example, data described herein as being stored by the media embedding system 130 may be stored in a blockchain distributed across a plurality of computing devices.

The media embedding system 130 may provide a dashboard or other interface for operators of the publisher 110 and media content provider 120 to submit electronic documents and media content items to the media embedding system 130 and manage information related to content embedding. For example, a content provider dashboard may show an operator of the content provider 120 which content items have been associated to electronic documents and how many times the content items have been viewed by users reading the documents. Similarly, a publisher dashboard may show an operator of the publisher 110 the content items that have been associated with the publisher's documents. The dashboards may also allow the operators to add or remove specific matches between content items and electronic documents. When a content provider 120 submits an electronic document to the media embedding system 130, the media embedding system 130 may send the content provider 120 an SDK for embedding media content items into the document.

The media embedding system 130 may also maintain an account for a user of the user device 140. A user's account information may include information explicitly provided by the user, such as a username selected by the user, financial information associated with the user (e.g., a credit card or bank account number), and a shipping address of the user. The user account may further include information automatically determined based on activities of the user with respect to electronic documents or media content items. For example, the user account may include a count of media content items with which the user interacts.

The user device 140 receives electronic documents and media content items and displays them to a user of the device 140. The user device 140 can be any device capable of displaying electronic content and communicating over the network 150, such as a desktop computer, laptop or notebook computer, mobile phone, tablet, eReader, television set, or set top box. The user device 140 may further include or be coupled to one or more input devices configured to receive inputs from the user, such as a mouse, keyboard, touch screen, eye movement tracker, hand gesture tracker, or microphone.

The network 150 enables communication between the publisher 110, media content provider 120, media embedding system 130, and/or user device 140. The network 150 may include one or more local area networks (LANs), wide-area networks (WANs), metropolitan area networks (MANs), and/or the Internet.

FIG. 1B is a schematic diagram illustrating an example implementation of the environment 100. As illustrated in FIG. 1B, the environment 100 can include several layers operating in tandem. At a highest level, an application layer 160 can be executed on the user device 140. The application layer 160 can display and media content items to a user and receive user inputs and actions related to an electronic document and the media content items. The user device 140 executes the application layer 160 while executing the computer readable code associated with an electronic document 162, such as a webpage. A consensus layer 164 matches media content items to portions of text in the document 162. A data layer 166 maintains data for the environment 100, including receiving electronic documents and media content items, storing user data, and tracking user interactions with media content items. One or both of the consensus layer 164 and data layer 166 may be executed by a centralized computing device associated with the media embedding system 130, such as a server. Alternatively, one or both layers may be decentralized, with operations associated with the layers executed by distributed nodes configured to write data to and read data from blocks in a blockchain 168. Finally, a dashboard 170 can provide information to a publisher 110 and/or media content provider 120 regarding associations between media content items and electronic documents.

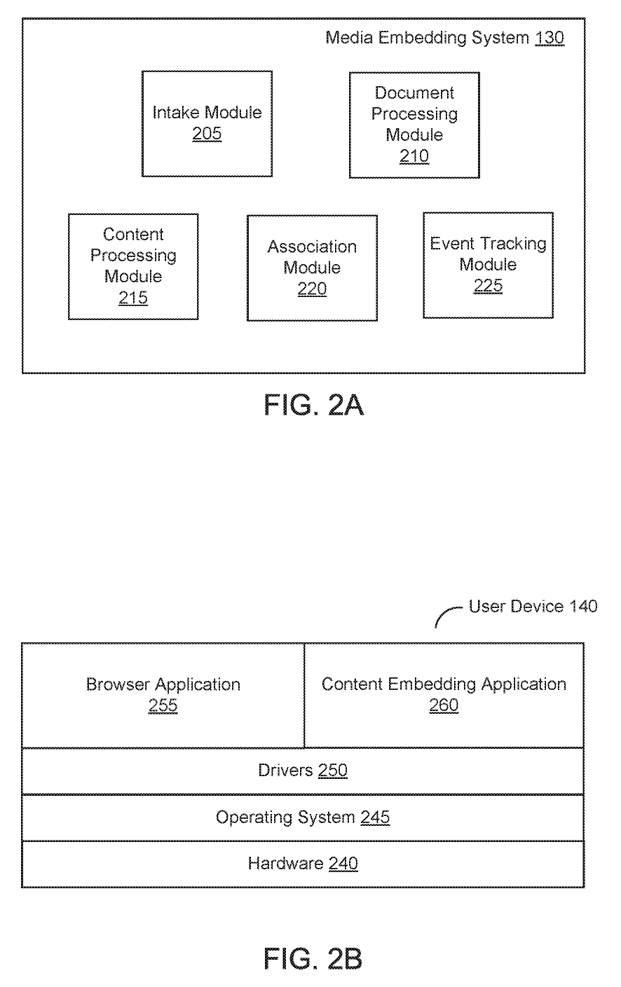

FIG. 2A is a block diagram illustrating functional modules executable by the media embedding system 130, according to one embodiment. The modules shown in FIG. 2A may include software executable by a processor of the media embedding system 130, hardware electronically coupled to the media embedding system 130, firmware, or any combination thereof. A module may or may not be self-contained. As shown in FIG. 2A, the media embedding system 130 may execute an intake module 205, a document processing module 210, a content processing module 215, an association module 220, and an event tracking module 225. Additional, fewer, or different modules may be executed by the media embedding system 130, and functionality of the media embedding system 130 may be distributed differently between the modules.

The intake module 205 receives identifications of media content items and electronic documents. The media content items may be provided to the intake module 205 by a media content provider 120, which can transmit the media content items to the intake module 205 (e.g., as a file) or send the intake module 205 a link to or an address of the media content items stored by the media content provider 120. When receiving identifications of the media content items, the intake module 205 may also receive descriptive information about the media content items from the media content provider 120. The descriptive information can describe the media content item itself, or can describe how the media content item should be distributed. For example, the descriptive information can include one or more keywords describing a subject matter of the content item. As another example, if the content item is an advertisement, the descriptive information can include information about when the content item should be embedded in an electronic document (e.g., campaign dates or times of day), into which electronic documents the content item should be embedded (e.g., subject matter or keywords associated with the electronic document), and for which users the content item should be embedded (e.g., targeting criteria such as demographic information or geographic region).

One or more publishers 110 provide electronic documents to the intake module 205. The publishers 110 may provide a link or address associated with each electronic document, such as a web address (e.g., a uniform resource locator (URL)). Alternatively, the publishers 110 may transmit the documents to the media embedding system 130 for receipt by the intake module 205. The publisher 110 associated with an electronic document may provide descriptive information for the electronic document, such as one or more keywords describing content of the document.

The document processing module 210 processes the electronic documents received from the publisher 110. The document processing module 215 may analyze the documents by any of a variety of natural language processing techniques, which apply computational methods to analyze and synthesize natural language and speech from the text. The natural language processing techniques used by the document processing module 215 may include, for example, neural networks, stochastic processes, supervised or unsupervised learning, manually-created classifiers, or lookup tables. In general, the document processing module 210 can convert a character stream extracted from a document into a sequence of lexical items, such as keywords or syntactic markers, through structure extractions and tokenizations. Based on the natural language processing analysis, the document processing module 210 can determine one or more keywords for the document. A document keyword can represent an analysis of a document overall, such as a topic most representative of the full text of the document. One or more document keywords may additionally or alternatively represent portions of a document. For example, the document processing module 210 may select, as a document keyword, a topic of one or more sentences or paragraphs in the document

When a document is received, the document processing module 210 can amalgamate sentences, paragraphs, or phrases in the document and output one or more keywords describing the document as a whole. For example, the document processing module 210 uses a maximal marginal relevance technique or a graph-based ranking algorithm to highlight an informative subset of sentences from the document.

The document processing module 210 can also analyze subsets of a document, such as sentences, to determine meanings of the sentences, extract keywords from the sentences, and identify commonalities between sentence keywords. To analyze sentences and other subsets of a document, the document processing module 215 can identify entities, parts of speech, and relationships among the words used in sentences in paragraphs. The document processing module 215 can identify parameters in text, such as enumerations, locations, dates, times, numbers, contacts, distances, or durations. Parts of speech can be tagged and matched, for example to associate adjectives and adverbs with the nouns and verbs they describe, link prepositions to their objects, and match pronouns or anaphoric verbs to their antecedents. The document processing module 215 can also identify named entities, such as companies, people, cities, or countries, searching for the names themselves, acronyms, hashtags, emails, uniform resource locators (URLs), or other identifiers associated with an entity. The document processing module 215 can then analyze predefined or learned relationships among the identified entities. For example, if the document is an article discussing a soft drink manufacturer, the document processing module 215 may identify that a sentence briefly mentioning a competitor's product is less important than other sentences in the document, even though the sentence discussing the competitor uses terms such as “soft drink” or “beverage” that are deemed relevant to the document.

The document processing module 210 may further analyze paragraphs, sentences, and phrases by other techniques such as lemmatization, stochastic grammar parsing, compound term processing, word sense disambiguation, or coreference resolution. Lemmatization uses a language dictionary to reduce word variations into root words, such as reducing plural nouns to singular, simplifying verb conjugations to an infinitive form, or decompounding compound words. Stochastic grammar parsing determines a parse tree for a sentence by analyzing relationships between words (such as predicates and objects in a sentence) and applying probabilistic context-free grammar to build out a parse tree from the relationships. Compound term processing matches two or more words in a sentence to create compound terms with meanings that may be distinct from the meanings of the individual words alone. For example, the document processing module 210 applies compound term processing to identify the compound term “triple base hit” in a sentence. Word sense disambiguation selects a meaning for a word or series of words that has several possible meanings, based on the context of the word in the sentence, document, or corpus of documents. In one embodiment, the document processing module 210 selects the word meaning by applying the word to a word sense disambiguation classifier that has been trained using a corpus of manually-annotated text. Coreference resolution identifies two or more words referring to the same object in a portion of text. For example, in the sentence, “He walked through Mary's house toward the living room window,” the document processing module 210 determines that the phrase “living room window” serves as a referred expression that bridges the relationship between “Mary's house” and “window.”

The document processing module 210 may further analyze sentiment of topics discussed across a document. Sentiment analysis is the extraction of subjective information from a corpus of text, such as a target document or a set of documents including a target document, and classification of a polarity of meaning, emotion, or opinion in the corpus. By analyzing sentiment of documents, the document processing module 210 may reduce the likelihood of a media content item being matched to a document that has relevant language but inappropriate context.

The document processing module 210 may also receive a document keyword from the publisher 110. If the publisher 110 provides a keyword, the document processing module 210 may compare the provided keyword to the extracted keyword or to the document text as a whole to verify that the keyword is relevant to the document. For example, the document processing module 210 determines whether the keyword appears within the text of the document, or determines whether the keyword is semantically related to the extracted keyword or text of the document.

The content processing module 215 processes the received media content items for embedding in an electronic document. A media content item including an audio file, such as an audio recording or a video, may be processed by cleaning the audio (e.g., to remove background noise or adjust volume or pitch) and transcribing the audio file into text. Words in the transcribed text can be timestamped for later reference, and sentences or phrases can be demarcated to infer punctuation in the transcription. The content processing module 215 may analyze the transcribed text to identify sentences or phrases in the text, determine a semantic meaning of the text, or extract a topic from the text. The content processing module 215 may analyze the text by techniques similar to those used by the document processing module 210 to analyze electronic documents. Based on the analysis of the text, the content processing module 215 determines one or more keywords for the media content item. A keyword can represent an analysis of a content item overall, such as a topic descriptive of the content item as a whole or a sentence representative of the content item text. A keyword may instead represent an analysis of a portion of a content item, such as a topic representative of a sentence extracted from the transcribed text.

The content processing module 215 may also receive one or more keywords from the content provider 120. In some cases, content providers may specify keywords for their content items when submitting the content items to the media embedding system 130. For example, if a media content item is a video advertisement for a car, the content provider associated with the content item may provide the keyword, “car,” when sending the content item to the media embedding system 130. The content processing module 215 may select an additional or different keyword for a media content item. In one embodiment, the content processing module 215 selects a keyword from the transcribed text of a content item. The keyword may be a single word, for example representing a subject matter of the content item, or a string of multiple words, such as a sentence selected from the transcribed text.

The content processing module 215 may generate a modified version of a content item. When the content item is a video, the content processing module 215 may generate a modified video by removing content from the video and/or isolating important content in the video, such as a speaker. For example, if a video shows a person speaking, the media embedding system 130 may remove at least a portion of background content from the video to isolate the speaker in the video. Content may be selected for removal by applying a convolutional neural network to the video to remove background images and other content in the frames of the video. The content processing module 215 may additionally or alternatively truncate a video or audio recording. For example, the content processing module 215 may identify a portion of the video or audio relevant to document text, such as a portion showing a person speaking a particular sentence, and generate a clip that includes the relevant portion and does not include another portion of the item.

The association module 220 associates media content items with portions of text in electronic documents. The association module 220 may match media content items with electronic documents based on similarities determined between varying degrees of document and content item granularity, such as matching sentences to sentences, sentences to keywords, keywords to keywords, sentences to a document or content item as a whole, or a document as a whole to a content item as a whole. In one embodiment, the association module 220 associates a media content item with a portion of text if a keyword associated with the media content item matches a keyword associated with the portion of text. The association module 220 can calculate a degree of similarity between the content item keyword and document keyword, and determine a match between the keywords if the similarity is greater than a threshold. For example, if the document processing module 210 selects the keyword “food” for a sentence in a document, the association module 220 determines a degree of similarity between “food” and a content item keyword “delicious” and matches the content item to the sentence if the degree of similarity is above the specified threshold.

In another embodiment, the association module 220 matches a media content item to a portion of text if a keyword associated with the media content item is itself included in the portion of text. For example, if the keyword of a content item is “car,” the association module 220 identifies an instance of the word “car” in the electronic document and matches the content item to the word itself, a sentence containing the word, or a paragraph containing the word. The association module 220 may use synonyms or subject matter proximity to match the content item to document text, for example matching the media content item to a portion of text including “vehicle,” “automobile,” “transportation,” or “driving.” Furthermore, based on the natural language processing analysis of the document text, the association module 220 may determine the semantic meaning of words in context in the document to improve the matching between the media content keyword and the portion of text. For example, the association module 220 analyzes semantics to match the media content keyword “car” to the word “driving” when it refers to a person operating a vehicle, not practicing a golf swing at the driving range.

As described above, the keyword of a media content item may include a plurality of words transcribed from the content item, such as a sentence spoken during the content item. In one embodiment, the association module 220 matches the media content item to a portion of text if a threshold number of consecutive words in the transcription match a corresponding number of consecutive words in the text of the electronic document. For example, a media content item that includes a reading of the Gettysburg Address may have, as a keyword, the phrase “Four score and seven years ago, our fathers brought forth on this continent.” Using a threshold of six words, the association module 220 matches the media content item to a portion of text in a document if the association module 220 finds “Four score and seven years ago” appearing consecutively in the document, but does not match the content item to an instance of the word “seven” appearing without other words in the keyword.

In some embodiments, the association module 220 matches content items to portions of text in an electronic document by selecting a content item related to the electronic document. A document may have one or more document keywords, which may be submitted by the publisher 110 or extracted from the document by the document processing module 210. The association module 220 may match a media content item to an electronic document by determining a similarity between the keyword of the content item and the document keyword. Once a content item has been selected, the association module 220 may match the content item to a portion of text in the document, for example by a process as described above. The similarity determined by the association module 220 may represent a degree of match between the content item and the document, and the association module 220 may determine that there is a match between the content item and the document if the similarity is greater than a specified threshold. For keywords comprising multiple words, similarity may represent a percentage of words in the content item keyword that match words in the document keyword. For example, if three of the five words in the content item keyword also appear in the document keyword, the similarity of the content item and the document may be determined to be 60%. Similarity may additionally or alternatively represent a semantic proximity between the content item keyword and the document keyword. To determine the semantic similarity between keywords, the association module 220 may access an ontology quantifying a distance between words or concepts and calculate the distance between one or more words in the content item keyword and one or more words in the document keyword.

In some embodiments, the association module 220 may receive matches between media content items and portions of text in electronic documents from the content provider 120, publisher 110, or user of the user device 140, and may associate the content items with the portions of text based on the received matches. For example, a web page provider may function as both a publisher 110 and a media content provider 120, and may send both an electronic document (e.g., a web page including a news article) and a media content item (e.g., a video showing a speech) to the media embedding system 130 with an explicit mapping between the video and one or more portions of text on the page. A news article including quotes from a State of the Union address, for example, can be provided with video clips of the speech such that the quotes in the article may each be associated with a playable video clip showing the president speaking the quote. Alternatively, the publisher 110 may select portions of text to associate with media content items, and the association module 220 identifies media content items matched to the selected portions. For example, the publisher 110 selects three portions of text in a news article each corresponding to a quote from the State of the Union address, and the association module 220 searches a video repository to identify a video clip showing the president speaking each quote.

The association module 220 may improve matching between media content items and portions of text over time by applying a machine learning algorithm to data associated with user interactions with embedded media content items. For example, the association module 220 learns that media content items with specified keywords receive more user attention when they are embedded in certain documents, and less attention when they are embedded in other documents. As another example, the association module 220 learns characteristics of users who are more likely to interact with certain types of content items than other users.

The event tracking module 225 receives event data from the user device 140 while the device displays an electronic document and stores the event data in a user account associated with the user of the device 140. The event data may include any actions performed at the user device 140 in relation to an electronic document, including displaying the document, scrolling the document, receiving a user input at a portion of text associated with an embedded media content item, or closing the document. Event data reported to the event tracking module 225 may be associated with a unique identifier of a user or user device 140, such as a username or a media access control (MAC) address. The user or device identifier may be associated with any electronic documents that incorporate the computer program instructions of the SDK distributed by the media embedding system 130. Accordingly, the event tracking module 225 can track a user's activities with respect to multiple electronic documents without, for example, storing a cookie to a browser used by the user.

The event data may also include a user input received at a displayed media content item. In one embodiment, the event tracking module 225 triggers a financial transaction related to a media content item in response to a user input at a displayed media content item. For example, the event tracking module 225 triggers a financial transaction to purchase a product shown in a media content item in response to a user tapping or clicking on a media content item. In response to the input, the event tracking module 225 may prompt a user to provide login credentials, such as a username and password, to log in to or create a user account that includes financial and shipping information necessary to complete the financial transaction. Once a user logs in, the event tracking module 225 may automatically associate the user account information with subsequent event data received from the user device 140. The user can then initiate a financial transaction with a single input, such as a tap or click on a media content item. By triggering a financial transaction in response to a user input at a content item, the event tracking module 225 enables the user to continue viewing the electronic document without leaving the document or waiting for the user device 140 to load another document.

Other example financial transactions that may be triggered in response to a user input directed to a displayed media content item include a content provider 120 paying a publisher 110 for an ad impression in response to the user input directed to the media content item, or the content provider 120 or publisher 110 paying a user for interacting with the media content item. In one embodiment, the event tracking module 225 determines a payment to the user for his interaction with a media content item based on an amount of time he interacts with the item. The amount of the payment can be determined based on a duration of a user input. For example, if a user taps and holds on a portion of text to view a content item, the payment to the user can increase as the amount of time the user holds on the portion of text (and therefore the amount of time the content item is displayed) increases. The relationship between user input duration and the amount of the payment may be, for example, linear, exponential, or logarithmic, optionally with a specified upper limit defining a maximum amount the user can earn for interacting with the content item. Increasing the user's payout as the duration of the user input increases may incentivize a user to interact with media content items more frequently and for longer lengths of time, thus increasing the likelihood of the user remembering, for example, an advertised product or brand. The event tracking module 225 may determine payouts to the user for other types of interactions with a content item. For example, the user may earn a specified amount for purchasing a product associated with a content item, sharing the content item with social networking connections, or providing comments or review for a content item.

The event data can further include information about a behavior of a user of the user device 140, and the event tracking module 225 may analyze the behavioral information to determine if the user is a human or a computer-implemented bot. The behavioral information may include, for example, a duration of the user input, a position of the user input relative to the displayed document and a screen on which the document is displayed, a surface area of the user input, spacing between portions of text in a document with embedded media content items, scroll rate of the document, ancillary input device movements on the document, consistence of input device gestures, and an amount of time the document is viewed. The event tracking module 225 may apply a heuristic or machine learning technique, such as a classifier, to the behavioral information to identify whether the user is a human or a bot. The behavioral information may be associated with a particular document, or the event tracking module 225 may track behaviors from a user device 140 over time to determine, for example, prolonged gesture behavior across multiple documents and sustained usage patterns.

FIG. 2B is a block diagram illustrating the user device 140, according to one embodiment. As shown in FIG. 2B, the user device 140 can include hardware 240, an operating system 245, and drivers 250, and can execute a browser application 255 and content embedding application 260. The user device 140 may include additional components not shown in FIG. 2B, including networking components,

The hardware 240 comprises physical components of the user device 140, including a processor, a memory, a display device, and one or more input devices, as well as data links, controllers, and other components used to operate and enable electronic communication between the processor, memory, display device, and input device. The operating system 245 comprises software executable by the hardware 240 that supports basic functionality of the user device 140. The drivers 250 facilitate communication between the operating system 245 and various other components of the user device 140, including input devices, the browser application 255, and the content embedding application 260.

The browser application 255 retrieves electronic documents and displays the documents to a user of the user device 140. The browser application 255 comprises software executable by the hardware 240, and may be a web browser, a mobile application, or other application configured to reconstruct and display an electronic document using instructions received from the publisher 110. For example, the browser application 255 constructs a web page using markup language transmitted to the user device 140 by the publisher 110. The browser application 255 may also facilitate user interactions with electronic documents, including reading the document, sharing the document with other users, and viewing media content embedded within text of the document.

The content embedding application 260 operates in parallel with and transparently to the browser application 255, and enables user interactions with media content embedded within electronic documents. When executed by the hardware 240, the content embedding application 260 displays selectable links at portions of text in an electronic document. If the user device 140 receives a user input directed to a selectable link, the content embedding application 260 detects that user input and retrieves and displays the media content item, for example in a modal window associated with a browser application-generated window. Furthermore, while a user views and interacts with an electronic document and embedded media content items, the content embedding application 260 collects event data and transmits the data to the media embedding system 130 for analysis by the event tracking module 225. Computer program code for the content embedding application 260 may be transmitted to the user device 140 with computer-readable code for electronic documents. Thus, the user device 140 may execute the content embedding application 260 while the browser application 255 displays a document with embedded media content items, whereas the content embedding application 260 may remain closed or idle while the browser application 255 displays documents with no embedded media content items. Portions of the content embedding application 260 may additionally or alternatively comprise computer program code that extends functionality of the browser application 255. For example, the content embedding application 260 may be a browser extension operating within the browser application 255.

### Embedding Media Content Items in Electronic Documents

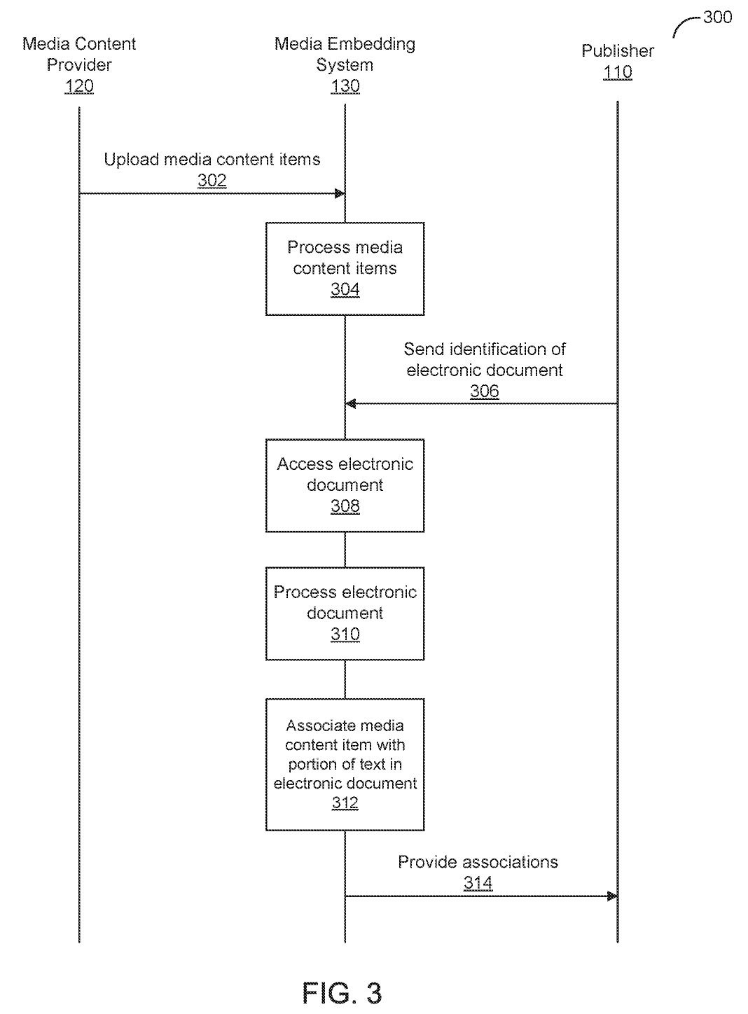

FIG. 3 is an interaction diagram illustrating a process 300 for associating media content items with portions of text in an electronic document, according to one embodiment. As shown in FIG. 3, the process 300 comprises interactions between a media content provider 120, the media embedding system 130, and a publisher 110. Other embodiments of the process 300 may include additional, fewer, or different steps, and may perform the steps in different orders.

As shown in FIG. 3, the media content provider 120 uploads 302 one or more media content items to the media embedding system 130. The media content provider 120 may upload 302 an item by sending a file to the media embedding system 130, or by sending a link to, address of, or identifier of the media content item stored by the media content provider 120 or other system. When sending a media content item to the media embedding system 130, the media content provider 120 may also provide descriptive information associated with the content item. The descriptive information may include a keyword describing the content item, for example to summarize a subject matter of the content item. The descriptive information may additionally or alternatively specify when or how the content item should be matched to electronic documents. For example, if the media content item is an advertisement, the content provider 120 may provide campaign dates, specifying a range of dates within which the media embedding system 130 may match the content item to an electronic document. Advertisements may also be associated with one or more targeting criteria specifying a user attribute. The media embedding system 130 may use the targeting criteria to associate the ad with an electronic document when it is requested by a user who satisfies the targeting criteria and not associate the ad with the document when the requesting user does not satisfy the targeting criteria. Example targeting criteria include demographic attributes of users (such as age or gender), location attributes of users (such as a geographic region from which a user accesses an electronic document), a type of device used by a user to access a document, or a time of day a document is accessed. Other descriptive information that may be provided with an advertisement include keywords of electronic documents to which the ad should be associated, or an advertising budget indicating a number of times the ad should be associated with electronic documents for a specified period of time (e.g., a budget for each day, each month, or for an entire ad campaign).

The media embedding system 130 receives the media content items from the media content provider 120 and processes 304 the content items. Processing 304 the content items may include transcribing audio from the content item into text and extracting a keyword from the transcribed text. Processing 304 may also include generating a modified version of a content item. For example, the media embedding system 130 may remove at least a portion of background content from a video to isolate a speaker in the video, or may generate a clip of an audio or video file.

A publisher 110 sends 306 the media embedding system 130 identifiers of electronic documents that include text. The publisher 110 may send 306 the media embedding system 130 an address associated with an electronic document, such as a web address of the document. Alternatively, the publisher 110 may send 306 content of electronic documents to the media embedding system 130, such as some or all of the text from the document. Publishers of mobile applications may send 306 a document by allowing the media embedding system 130 access to the application when it is executed, enabling the media embedding system 130 to extract text from the application. Publishers may provide keywords describing the content of their electronic documents, or may identify particular portions of text the publisher would like to have associated with media content items.

The media embedding system 130 accesses 308 an electronic document provided by the publisher 110 and processes 310 the document. Processing 310 the document may include indexing text of the document and extracting one or more keywords from the text based on a natural language processing analysis. The media embedding system 130 may also receive a keyword of the document from the publisher 110.

The media embedding system 130 associates 312 a portion of text in the electronic document with a media content item based on a determined match between the media content item and the portion of text. The media embedding system 130 may match a portion of the media content item (such as a sentence) to the portion of text, a keyword of the media content item to the portion of text, a keyword of the portion of text to a portion (e.g., a sentence) of the media content item, the portion of text of the document to the media content item as a whole, or a portion of the media content item to the document as a whole. The media embedding system 130 may determine the match between the media content item and the portion of text by, for example, identifying a portion of text that has a keyword matching the keyword of the content item, identifying a portion of text that includes the keyword of the content item, or identifying a portion of text that is topically or semantically similar to the content item keyword. In one embodiment, the media embedding system 130 associates 312 a portion of text with a media content item by determining a match between a keyword of the media content item and a keyword of the portion of text, where both keywords are selected based on natural language processing of the respective content. In another embodiment, the media embedding system 130 associates 312 a media content item and portion of text by analyzing a sentence of the media content item and a sentence of the electronic document by natural language processing and determining a match between the sentences. In yet another embodiment, the media embedding system 130 associates 312 a media content item and portion of text by analyzing most or all of the electronic document, including text other than the portion associated with the media content item, and determining a similarity between the media content item and the electronic document as a whole. Alternatively, the media embedding system 130 may receive a match between a media content item and a portion of text from the publisher 110 or content provider 120, and may associate the media content item with the portion of text based on the received match.

The media embedding system 130 provides 314 the associations between media content items and portions of electronic documents to the publisher 110. Associations between media content items and portions of text may be provided for each electronic document submitted by a publisher 110, and may comprise, for example, an index mapping identifiers of content items to respective portions of text in the document. The associations may further include a location of the media content item, such as an address at which the content provider 120 or media embedding system 130 stores the media content item. The publisher 110 may use the associations to link the media content items to the portions of text.

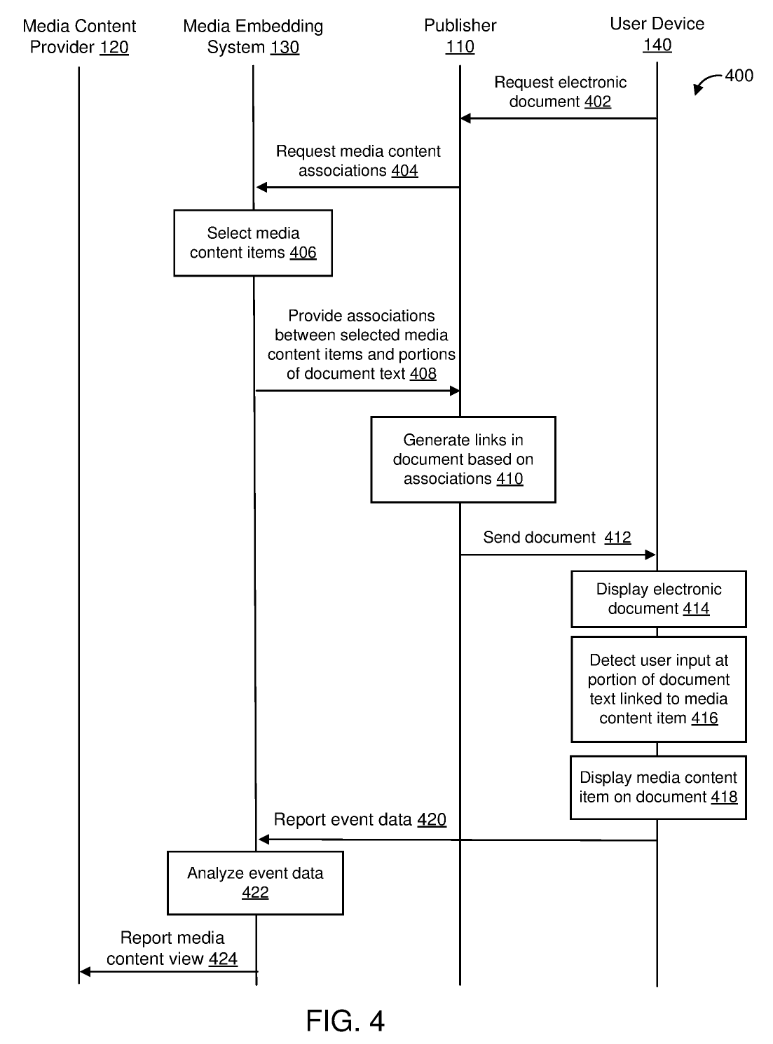

FIG. 4 is an interaction diagram illustrating a process 400 for embedding media content items into portions of text in an electronic document, according to one embodiment. As shown in FIG. 4, the process 400 comprises interactions between a media content provider 120, the media embedding system 130, a publisher 110, and a user device 140. Other embodiments of the process 400 may include additional, fewer, or different steps, and may perform the steps in different orders.

The user device 140 requests 402 an electronic document, such as a web page. With the document request, the user device 140 may transmit information about the user of the device 140. The user information may be sent to the media embedding system 130 within a secure smart contract encrypting attributes of the user, financial information of the user, or other sensitive information about the user. The smart contract defines a protocol for exchange of information between the user device 140 and media embedding system 130, and may be stored in a blockchain to secure the user information.

In response to the request 402, the publisher 110 may request 404 associations between media content items and the requested electronic document from the media embedding system 130. The publisher 110 may transmit the user information to the media embedding system 130 with the request 404. In another embodiment, the publisher 110 retrieves associations previously provided by the media embedding system 130.

The media embedding system 130 selects 406 one or more media content items, and provides 408 the publisher 110 with associations between the selected media content items and portions of the text in the electronic document. In some cases, the media embedding system 130 may send the publisher 110 associations for any content items matched to portions of the document. In other cases, content items may be selected based in part on descriptive information of the media content item or attributes of the user requesting the document. For example, if content items are associated with targeting criteria, the media embedding system 130 selects, from a plurality of content items, a selected media content item based on a match between the targeting criterion of the content item and an attribute of the user. In this case, if, for example, a plurality of video advertisements are matched to the word “car” in a document, the media embedding system 130 may select a video ad for a mid-level car when the document is viewed by a user with a middle class salary, while selecting a video ad for a luxury vehicle when the document is viewed by a user with a higher salary. As another example, content items may be associated with an advertising budget specifying a target frequency for embedding each content item in electronic documents. The media embedding system 130 may determine a number of times each of a plurality of content items have been embedded in electronic documents during a specified period of time, and may select a content item whose embedding frequency is less than the target frequency. Once a content item has been selected, the media embedding system 130 sends the publisher 110 an association between the selected media content item and a portion of text in the electronic document.

Based on the associations, the publisher 110 generates 410 selectable links in the electronic document. The publisher 110 may generate the links using an SDK distributed by the media embedding system 130, which incorporates executable computer program instructions into instructions related to the electronic document. When executed, the incorporated instructions may generate the link to a media content item and a user interface layer within the electronic document that can be displayed by the user device 140. Each selectable link may include a location of the corresponding media content item, enabling the user device 140 to retrieve and display the media content item when the link is selected. Furthermore, each link may comprise a user interface element displayable by the user device 140 in association with a portion of text in an electronic document. For example, the publisher 110 may add a hyperlink into a document and replace a portion of plain text with link text of the hyperlink. Alternatively, the publisher 110 may add a user interface element to the electronic document that overlays, is adjacent to, or otherwise is associated with a portion of document text. The link may be visually distinguished from other content of the document by, for example, a shape, text color, text size, font, or font style not used for portions of the document text that are not associated with media content items. The link may also include an animation that is displayed, for example, when a user selects the link, when an input device is positioned near the link, when the electronic document is first displayed by the user device 140, or at random intervals. Because the SDK executed by the publisher 110 may control how the entire document is displayed, the animation can be displayed over or in association with any portion of the document page. For example, the animation can include a visual effect of the link or portion of text, such as scrolling a visual indicator of the link, changing the color or highlighting the portion of text, or causing the link or portion of text to blink on and off. Alternatively, the animation can include a visual effect associated with the electronic document as a whole, such as a color change of the background of the document, an animation of fireworks over the document or streamers falling down the document page, or a rotation or zoom of the document.

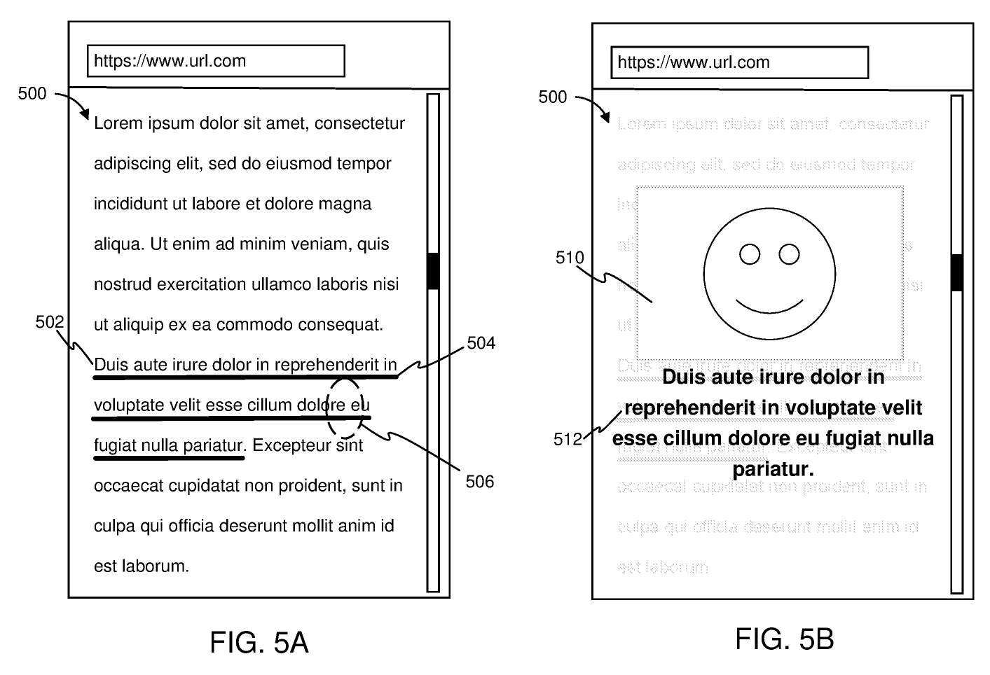

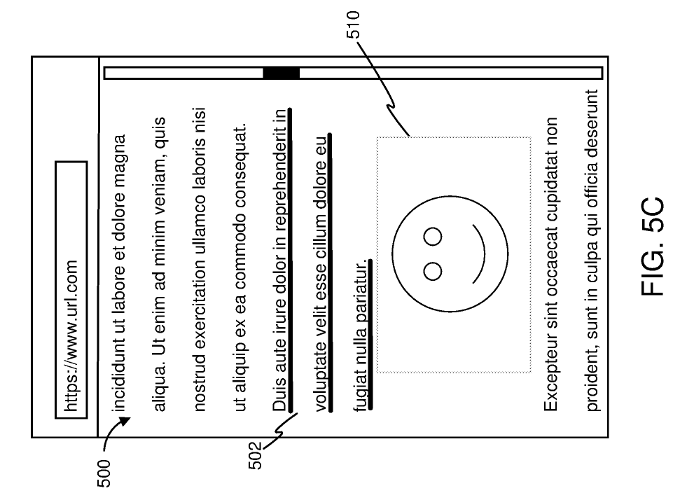

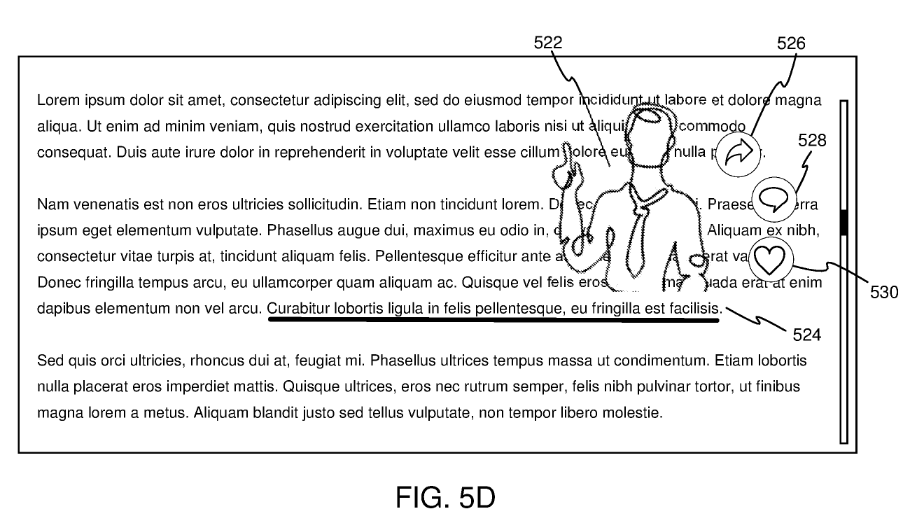

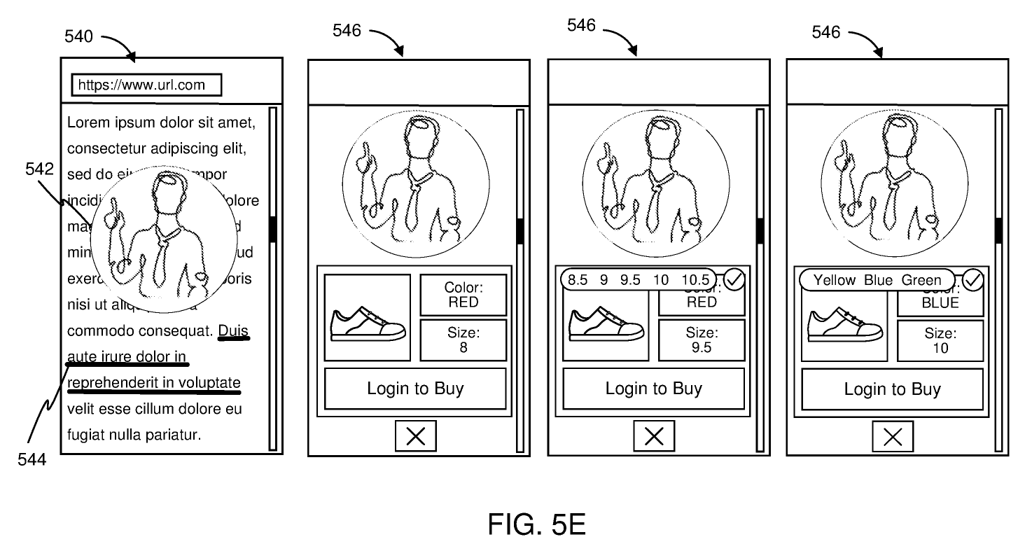

The publisher 110 sends 412 the document with embedded links to the user device 140, which displays 414 the document to the user. FIG. 5A illustrates an example electronic document 500 displayed by the user device 140. In the example of FIG. 5A, a portion 502 of text is associated with a media content item. The link generated by the publisher 110 may be displayed as a selectable user interface element 504 associated with the text portion 502, such as an underline under the text portion 502, or any other manner of indicating to the user that a link is associated with the text.

Referring to FIGS. 4 and 5A, the user device 140 detects 416 a user input at the selectable link associated with a portion of document text. The user input may comprise, for example, a click received at the displayed link or a touch input received at the displayed link. In response to the user input, the user device 140 accesses the media content item from a location specified by the selectable link, and displays 418 the media content item on the document. The media content item may be displayed in a modal window associated with a window displaying the document, in an HTML overlay over the document, or in the document itself (e.g., in a division element that is hidden prior to the user input and activated in response to the user input). In one embodiment, the user device 140 displays the media content item if a characteristic of the user input satisfies a display criterion associated with the link. The display criterion may be a threshold duration of the user input. For example, if the threshold duration is three seconds, the user device 140 displays the media content item if the user touches and holds or clicks and holds on the linked portion of text for at least three seconds. Alternatively, the user device 140 may display the media content item in response to a start of a user input (e.g., a tap or click), and continue to display the media content item for a duration of the user input. For example, if a user touches and holds the portion of text associated with a media content item, the user device 140 displays 418 the item only as long as the touch input persists, and closes the item when the touch input is removed. Other example display criteria that may be used to determine whether to display the media content item include a number of user inputs (e.g., at least two clicks or taps within a specified period of time), or a direction of the user input (e.g., a swipe moving upward on a display of the user device for at least a specified distance).

FIG. 5B illustrates an example media content item 510 displayed on (e.g., superimposed over) the document 500 and played, in response to selection of the link 504. The portion of text 502 associated with the media content item 510 may be emphasized and displayed with the media content item 510 as a caption 512. The media content item 510 is displayed within the context of the document 500 without, for example, opening a new window of the application displaying the document 500 (e.g., a new browser window). In the example of FIG. 5B, the media content item 510 is shown overlaid on text of the document 500, for example in an HTML overlay element. However, rather than displayed in an overlay, the media content item 510 may be displayed adjacent to text of the document 500, or the document text may be moved up the page, down the page, or to a side of the page to allow space for the media content item 510 to be displayed. FIG. 5C, for example, shows text below the portion 502 has been moved down the document page to allow the media content item 510 to be displayed in line with the document text.

When displayed 418, the media content item can be automatically played. For example, if the content item is a video, the video may start playing in response to the user input 506. Furthermore, the media content item displayed by the user device 140 may be a modified version of the item submitted by the content provider, for example truncated to correspond to the associated portion of text or modified to show a person speaking in isolation from other content of the video.

Additional functionality associated with a media content item may be displayed automatically or in response to a second display criterion. The additional functionality can include an option to purchase a product or service associated with the content item, an option to comment on or review the media content item, or social networking functions such as controls for sharing or liking the content item. The second display criterion can include, for example, a duration of a user input (e.g., holding for at least three seconds), a specified gesture (e.g., an upward swipe), or a specified number of user inputs (e.g., at least two clicks). The user device 140 may also enable users to submit comments related to displayed media content items or view comments submitted by other users who viewed the media content item.

FIG. 5D illustrates an example of additional functionality displayed with a media content item. In FIG. 5D, a media content item 522 is associated with a portion of text 524 in a document 520. The media content item 522 may be persistently displayed in response to a first user input, such as a touch or click on the portion of text 524. The user device 140 may close the media content item 522 in response to a second user input outside a region associated with the media content item 522. While displaying the media content item 522, the user device 140 displays a button 526 to share the item 522, a button 528 to comment on the item, and a button 530 to like the item.

FIG. 5E illustrates another example of additional functionality displayed with a media content item. In FIG. 5E, a media content item 542 is associated with a portion of text 544 in a document 540. The media content item 542 may be persistently displayed in response to a first user input, such as a touch or click on the portion of text 544. The user device 140 may close the media content item 542 in response to a second user input outside a region associated with the media content item 542. In response to a user input directed to the media content item 542, the user device 140 may display an option screen 546 to select features of a product for purchase (such as color and size of a pair of shoes associated with the media content item 542).

The user device 140 may close the media content item in response to absence of a user input. For example, the user device 140 displays a media content item while the user provides a continuous touch input at the associated portion of text, and closes the media content item when the touch input is removed. Similarly, the user device 140 may display a media content item while a cursor hovers over the associated portion of text, and closes the item when the user moves the cursor to another location on the document. The user device 140 may alternatively close the media content item in response to another user input, such as a tap or click on a portion of the display outside the media content item 510. Closing the media content item can cause the user device 140 to restore normal display of the document 500 without any visible media content items, as shown for example in FIG. 5A.

The user device 140 may report 420 event data related to a document or media content item to the media embedding system 130. The event data can include a notification that the media content item was viewed by the user, a subsequent user input at a displayed media content item, an input of a comment associated with a media content item, or other user interactions with an electronic document or media content item.

The media embedding system 130 analyzes 422 the event data. If the event data includes a user input received at a displayed media content item, the media embedding system 130 may trigger a financial transaction in response to the event data corresponding to the user input. For example, the subsequent user input may cause the media embedding system 130 to trigger a financial transaction to enable the user to purchase a product or pay for a service related to the content item. The media embedding system 130 may decrypt financial information of the user, such as a bank account or credit card number, from a smart contract transmitted by the user device 140 when the electronic document is requested. If the event data includes a comment on a media content item submitted by the user, the media embedding system 130 may store the comment and display it to other users who view the media content item.

The media embedding system 130 may also use the event data to track a number of views of media content items. In some cases, users may receive a financial payout for viewing content items to incentive the users to view the items. The media embedding system 130 may therefore maintain a count of the number of content items viewed by a user, and remunerate the user periodically (e.g., once per month) based on the count. In other cases, the media content provider 120 may pay the media embedding system 130 based on a number of embedded media content items viewed by users. Accordingly, the media embedding system 130 may report 422 a content item view to the content provider 120. For example, if the media content item is an advertisement, the user input is reported to the content provider 120 as an impression associated with the ad. In one embodiment, the media embedding system 130 analyzes 422 the event data to determine whether the user input was provided by a person or a computer-implemented bot, and thereby determine if the content item was viewed by a person. If the media embedding system 130 determines the user to be a person based on the behavioral information, the media embedding system 130 may report 422 a view of a media content item to the content provider 120. If the media embedding system 130 determines the user is likely a bot, the view may not be reported to the content provider 120.

### Processing System

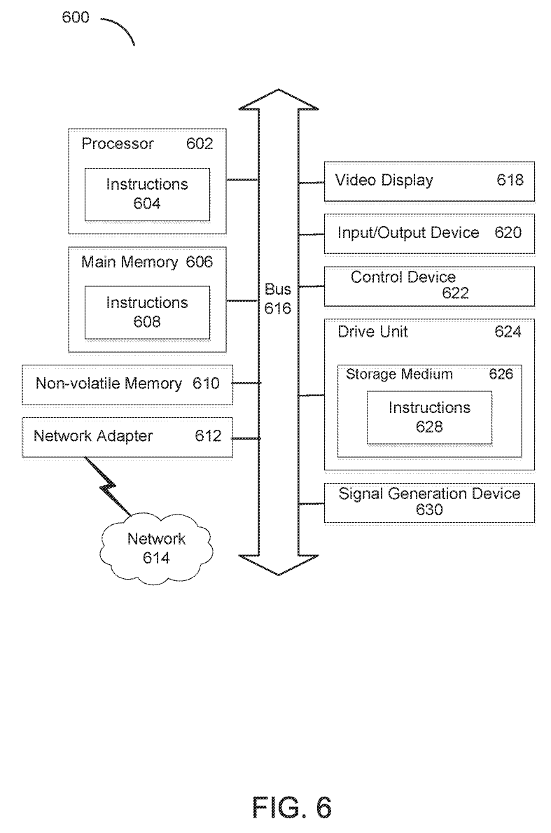

FIG. 6 is a block diagram illustrating an example of a processing system 600 in which at least some operations described herein can be implemented. For example, one or more of the publisher 110, the content provider 120, and the media embedding system 130 may be implemented as the example processing system 600. The processing system 600 may include one or more central processing units (“processors”) 602, main memory 606, non-volatile memory 610, network adapter 612 (e.g., network interfaces), video display 618, input/output devices 620, control device 622 (e.g., keyboard and pointing devices), drive unit 624 including a storage medium 626, and signal generation device 630 that are communicatively connected to a bus 616. The bus 616 is illustrated as an abstraction that represents any one or more separate physical buses, point to point connections, or both connected by appropriate bridges, adapters, or controllers. The bus 616, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, also called “Firewire.”

In various embodiments, the processing system 600 operates as part of a user device, although the processing system 600 may also be connected (e.g., wired or wirelessly) to the user device. In a networked deployment, the processing system 600 may operate in the capacity of a server or a client machine in a client-server network environment, or as a peer machine in a peer-to-peer (or distributed) network environment.

The processing system 600 may be a server computer, a client computer, a personal computer, a tablet, a laptop computer, a personal digital assistant (PDA), a cellular phone, a processor, a web appliance, a network router, switch or bridge, a console, a hand-held console, a gaming device, a music player, network-connected (“smart”) televisions, television-connected devices, or any portable device or machine capable of executing a set of instructions (sequential or otherwise) that specify actions to be taken by the processing system 600.

While the main memory 606, non-volatile memory 610, and storage medium 626 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 628. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 604, 608, 628) set at various times in various memory and storage devices in a computer, and that, when read and executed by one or more processing units or processors 602, cause the processing system 600 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. For example, the technology described herein could be implemented using virtual machines or cloud computing services.

Further examples of machine-readable storage media, machine-readable media, or computer-readable (storage) media include, but are not limited to, recordable type media such as volatile and non-volatile memory devices 610, floppy and other removable disks, hard disk drives, optical disks (e.g., Compact Disk Read-Only Memory (CD ROMS), Digital Versatile Disks (DVDs)), and transmission type media, such as digital and analog communication links.

The network adapter 612 enables the processing system 600 to mediate data in a network 614 with an entity that is external to the processing system 600 through any known and/or convenient communications protocol supported by the processing system 600 and the external entity. The network adapter 612 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 612 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

1. A method comprising:
displaying, at a portion of text in an electronic document displayed by an application that executes in the user device, a selectable link referencing a playable media content item, the portion of text having been associated with the playable media content based upon a match between a keyword of the portion of text and a targeting criterion of the playable media content corresponding to a user attribute;
detecting a first user input directed to the selectable link;
responsive to a duration of the user input being greater than a threshold duration, causing the user device to generate a modal window on a window in which the electronic document is displayed by the application and to play the media content item in the modal window;
receiving a single second user input directed to the displayed media content item; and
responsive to the second user input, triggering a financial transaction to purchase an item associated with the displayed media content item.

2. The method of claim 1, further comprising:
responsive to termination of the user input, automatically closing the modal window.

3. (canceled)

4. The method of claim 1, further comprising:
writing financial information of the user into a smart contract; and
using the smart contract to perform the financial transaction.

5. The method of claim 1, further comprising:
reporting behavioral information related to user interactions with the electronic document to a server, the server being configured to determine whether the user is a computer-implemented bot based on the behavioral information.

6. A non-transitory storage medium storing program code, execution of which in a mobile user device including a touch screen display causes the mobile user device to perform steps comprising:
receiving association information for associating a video content item and a portion of an electronic document, the association information having been determined based on a match between the video content item and a keyword associated with the portion of the electronic document;
generating a selectable link corresponding to the portion of the electronic document based on the association information;
displaying, at the portion of the electronic document the selectable link associated with a playable video content item;
detecting a first user input that includes a touch input on the touch screen display and directed to the selectable link, the touch input having a duration; and
for the duration of the touch input, causing the user device to generate a modal window on a window in which the electronic document is displayed by the application and to play the video content item in the modal window.

7. The non-transitory storage medium of claim 6, wherein execution of the program code in the mobile user device further causes the mobile user device to:
responsive to termination of the first user input, automatically close the modal window.

8. The non-transitory storage medium of claim 6, wherein execution of the program code in the mobile user device further causes the mobile user device to:
receive a single second user input directed to the displayed video content item; and
responsive to the second user input, trigger a financial transaction related to the video content item.

9. The non-transitory storage medium of claim 6, wherein execution of the program code in the mobile user device further causes the mobile user device to:
report behavioral information related to user interactions with the electronic document to a server, the server being configured to determine whether the user is a computer-implemented bot based on the behavioral information.

10. A method comprising:
accessing an electronic document that includes text; and
incorporating computer program code into the electronic document, the incorporated computer program code including instructions, execution of which by a user device will cause the user device to, while displaying the electronic document:
receive association information associating a video content item and a portion of the electronic document, the association information determined based in part on a match between the video content item and a keyword associated with the portion of the electronic document;
generate a selectable link corresponding to the portion of the electronic document based on the association information;
responsive to a first user input directed to the selectable link that is displayed at the portion of the electronic document and referencing the video content item, cause the user device to generate a modal window to display the video content item;
receive a single second user input directed to the displayed video content item; and
responsive to the second user input, trigger a financial transaction to purchase an item associated with the displayed video content item.

11. The method of claim 10, wherein the incorporated computer program instructions when executed further cause the user device to:
report event data related to user interactions with the electronic document to a server.

12. The method of claim 11, wherein the event data comprises behavioral information relating to interactions by a user with the electronic document, and the server being configured to determine whether the user is a computer-implemented bot based on the behavioral information.

13. The method of claim 10, wherein the incorporated computer program instructions when executed further cause the user device to display an animation associated with the selectable link.

14. The method of claim 10, wherein the incorporated computer program instructions when executed further cause the user device to:
display user content related to the video content item while displaying the video content item, the user content comprising at least one of a comment submitted by a user, user feedback on the content item, and an identifier of a user who has purchased an item associated with the video content item.

15. The method of claim 10, further comprising:
receiving, via a computer network, an association between the video content item and the portion of text, the association having been determined based on a match between the video content item and a keyword associated with the portion of text; and
generating the selectable link based on the association.

16. The method of claim 10, wherein the incorporated computer program instructions when executed further cause the user device to:
transmit financial information of a user of the user device to a server; and
responsive to the second user input, transmit an indication of the second user input to the server to trigger a financial transaction related to the video content item using the financial information.

17. The method of claim 16, wherein the incorporated computer program instructions cause the user device to display the video content item prior to receiving login credentials from a user of the user device, and wherein the incorporated computer program instructions when executed further cause the user device to:
receive the login credentials from the user of the user device;
wherein the financial information is transmitted to the server in association with the login credentials.

18. The method of claim 16, wherein the incorporated computer program instructions when executed further cause the user device to write the financial information of the user into a smart contract.

19. The method of claim 10, wherein the incorporated computer program instructions when executed further cause the user device to:
cause a payment to be transferred to a user of the user device in response to the first user input, wherein an amount of the payment is determined based on the duration of the first user input.

20. The method of claim 10, further comprising:
receiving an identification of the portion of text; and
searching a database of transcribed video content items to identify a video content item including text that matches the portion of text;
wherein the selectable link is associated with the identified video content item.
